(19) United States
(12) Patent Application Publication
(10) Pub. No.: US 2020/0183558 A1
(43) Pub. Date: Jun. 11, 2020

(54) METHOD AND AN APPARATUS FOR PROVIDING A DESKTOP

(71) Applicant: SHANGHAI ZHANGMEN SCIENCE AND TECHNOLOGY CO., LTD., Shanghai (CN)

(72) Inventors: Danian Chen, Shanghai (CN); Chao Gao, Shanghai (CN)

(21) Appl. No.: 16/793,001

(22) Filed: Feb. 18, 2020

Related U.S. Application Data
(63) Continuation of application No. PCT/CN2018/098514, filed on Aug. 3, 2018.

(30) Foreign Application Priority Data
Aug. 18, 2017 (CN) 201710714436.0
Sep. 15, 2017 (CN) 201710835501.5

(51) Int. Cl. G06F 3/0484; G06F 3/0481; G06F 3/0482; H04L 29/08

(52) U.S. Cl. CPC G06F 3/0484; G06F 3/04817; H04L 67/306; H04L 67/26; G06F 3/0482

(57) ABSTRACT

A method and an apparatus for providing a desktop: a network device determining one or more pieces of candidate desktop information corresponding to a mobile device from an application message pushed by an application server (S21), and sending the one or more pieces of candidate desktop information to the mobile device (S22); the mobile device determining one or more pieces of desktop information from the one or more pieces of candidate desktop information based on a user profile model of a corresponding user (S11), wherein the one or more pieces of candidate desktop information includes candidate desktop information provided by the corresponding network device, and presenting a current desktop of the mobile device according to the one or more pieces of desktop information (S12). The above method and apparatus may implement a “personalized” effect of desktop presentation, increase usage efficiency of users, and improve user experience of users.

### CROSS REFERENCE TO THE RELATED APPLICATION

This application is the continuation application of International Application No. PCT/CN2018/098514, filed on Aug. 3, 2018, which is based upon and claims priority to Chinese Patent Application No. 201710714436.0, filed on Aug. 18, 2017, and Chinese Patent Application No. 201710835501.5, filed on Sep. 15, 2017, the entire contents of which are incorporated herein by reference.

### TECHNICAL FIELD

The present application relates to communication, and more particularly relates to a technology for providing a desktop.

### BACKGROUND

Mobile devices often display a series of application icons on their display screen desktop for users to select and start corresponding applications. Generally, a user makes a device to display a desktop with a list of application icons in a way of pressing or clicking the “Home” button, sliding to unlock, or password unlocking, etc. After the user locates a desired application icon in the list of application icons, the user clicks the application icon (sometimes a page flipping operation is required first) to launch the corresponding application. If the user needs to view the information provided by the application itself, he/she sometimes needs to perform other operations. For example, in order to view interaction messages in a social application, the user first looks for the application icon of the social application in the desktop icon list, clicks to launch the social application, then clicks to enter the “Messages” tab, and finally clicks a corresponding message or module and views updates.

### SUMMARY

It is an object of the present application to provide a method for providing a desktop.

According to some embodiments of the present application, a method for providing a desktop at a mobile device is provided. The method comprises: acquiring one or more pieces of desktop information of the mobile device, wherein the one or more pieces of desktop information may be selected and determined based on a user profile model of a corresponding user of the mobile device; presenting a current desktop of the mobile device according to the one or more pieces of desktop information.

According to some embodiments of the present application, a method for providing a desktop at a network device is provided. The method comprises: determining one or more pieces of candidate desktop information corresponding to a mobile device from an application message pushed by an application server; sending the one or more pieces of candidate desktop information to the mobile device.

According to some embodiments of the present application, a method for providing a desktop is provided. The method comprises: determining, by a network device, one or more pieces of candidate desktop information corresponding to a mobile device from an application message pushed by an application server, and sending the one or more pieces of candidate desktop information to the mobile device; determining, by the mobile device, one or more pieces of desktop information from the one or more pieces of candidate desktop information based on a user profile model of a corresponding user, wherein the one or more pieces of candidate desktop information includes candidate desktop information provided by the corresponding network device; presenting, by the mobile device, a current desktop of the mobile device according to the one or more pieces of desktop information.

According to some embodiments of the present application, a mobile device for providing a desktop is provided. The mobile device comprises: a processor; and a memory configured to store computer executable instructions, wherein the executable instructions, when executed, cause the processor to: acquire one or more pieces of desktop information of the mobile device, wherein the one or more pieces of desktop information may be selected and determined based on a user profile model of a corresponding user of the mobile device; present a current desktop of the mobile device according to the one or more pieces of desktop information.

According to some embodiments of the present application, a network device for providing a desktop is provided. The network device comprises: a processor; and a memory configured to store computer executable instructions, wherein the executable instructions, when executed, cause the processor to: determine one or more pieces of candidate desktop information corresponding to a mobile device from an application message pushed by an application server; send the one or more pieces of candidate desktop information to the mobile device.

According to some embodiments of the present application, a computer readable medium comprising instructions is provided, wherein the instructions, when executed, cause a system to: acquire one or more pieces of desktop information of a mobile device, wherein the one or more pieces of desktop information may be selected and determined based on a user profile model of a corresponding user of the mobile device; present a current desktop of the mobile device according to the one or more pieces of desktop information.

According to some embodiments of the present application, a computer readable medium comprising instructions is provided, wherein the instructions, when executed, cause a system to: determine one or more pieces of candidate desktop information corresponding to a mobile device from an application message pushed by an application server; send the one or more pieces of candidate desktop information to the mobile device.

In the prior art, a user makes a device to display a desktop by unlocking the device, clicking the “Home” button and the like. The desktop displayed by the device usually includes several application icons for users to select directly. The user needs to locate and launch an application in a list of applications for desired services. It is a common practice in the industry to display a desktop containing several application icons directly after the device is started, unlocked, or pressed by the “Home” button (if the application icons are spread across multiple desktop pages, usually one of the desktop pages is displayed), to which users are already accustomed. In addition, if a user wants to view information updates in different applications, he/she has to open each application to find them.

Compared with the prior art, according to some embodiments of the present application, by sorting and presenting application information, application information such as applications, notifications, pushes, or in-app independent content that are currently most needed by the user may be dynamically and presented on the mobile device. Because such presentation is based on a user profile model, the information presented on the mobile device is dynamic and personalized to the user. The desktop presented to the user by the mobile device is thus “personalized”. According to some embodiments of the present application, the user is prevented from the trouble of finding a desired application from a fixed list of applications or performing further operations to view in-app independent contents. The user may browse information from different applications directly on the desktop of the mobile device. Because such information is obtained through personalized screening, the amount of information browsing required for the user is significantly reduced. In addition, according to some embodiments of the present application, when it is detected that a trigger condition for presenting the desktop is satisfied, such as when it is detected that the device is unlocked or started, the “Home” button is pressed, the “personalized” desktop is directly presented, thus breaking the inertia of thinking in the field. The present application may greatly broaden the channels for users to obtain information, improve user efficiency, and enhance user experience.

### DESCRIPTIONS OF THE DRAWINGS

Other features, objects, and advantages of the present application will become more apparent by reading the detailed description of non-limiting embodiments with reference to the following drawings:

FIG. 1 shows a flowchart of a method for providing a desktop at a mobile device according to some embodiments of the present application;

FIG. 2 shows a flowchart of a method for providing a desktop according to some other embodiments of the present application;

FIG. 3 shows a schematic diagram of a system for providing a desktop according to some embodiments of the present application;

FIGS. 4 to 7 respectively show a schematic diagram of a desktop of a mobile device according to some embodiments of the present application;

FIG. 8 shows a schematic diagram of a refresh process of a current desktop by a mobile device according to some embodiments of the present application;

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which may be used to store information that may be accessed by a computing device.

The devices referred to in the present application include, but are not limited to, user equipments, network devices, or devices formed by the integration of user equipments and network devices through a network. User equipments include but are not limited to any type of mobile electronic products capable of human-machine interaction with users (e.g., via touchpads), for example, an intelligent phone, a tablet, etc. The mobile electronic products may run on any operating system, such as android operating system, iOS operating system, etc. Network devices include an electronic device of automatically performing numeral calculations and information processing according to preset or stored instructions. It's hardware includes but is not limited to micro-processors, application specific integrated circuits (ASIC), programmable logic device (PLD), field programmable gate array (FPGA), digital signal processors (DSP), embedded devices, etc. Network devices include but are not limited to: computers, mainframes, single network server, a cloud composed of multiple network server sets or multiple servers. Cloud as used herein is formed by a massive amount of computers or network servers based on cloud computing, wherein cloud computing is a type of distributed computing, which is a virtual super computer composed of a group of loosely coupled computer sets. Networks include but are not limited to internet, Wide Area Network (WAN), Metropolitan Area Network (MAN), Local Area Network (LAN), Virtual Private Network (VPN), wireless ad-hoc network, etc. In one embodiment, the device may also be programs running on user equipments, network devices, or user equipments and network devices, network devices, touch terminals, or a device composed by integration of network devices and touch terminals through a network.

Of course, it may be appreciated by those skilled in the art that the above mentioned device is merely an example. Other existing devices or those that may appear in the future fall within the protection scope of the application and are incorporated herein by reference, if applicable to the present application.

In the description of the present application, the term “a plurality of” means two or more, unless it is clearly and specifically defined otherwise.

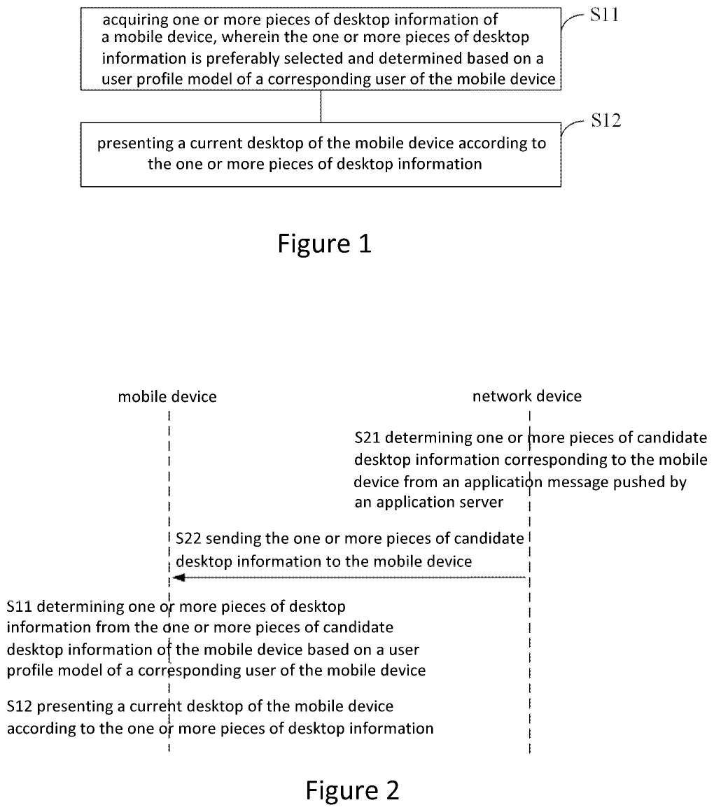

FIG. 1 shows a flowchart of a method for providing a desktop at a mobile device according to some embodiments of the present application. The method comprises step S11 and step S12. The method is described in detail below using a mobile device for presenting a desktop to a user as an example. At step S11, the mobile device acquires one or more pieces of desktop information of the mobile device, wherein at least one of the one or more pieces of desktop information may be selected and determined based on a user profile model of a corresponding user of the mobile device. At step S12, a current desktop of the mobile device is presented according to the one or more pieces of desktop information.

Specifically, at step S11, one or more pieces of desktop information of the mobile device is acquired, wherein at least one of the one or more pieces of desktop information may be selected and determined based on the user profile model of the user corresponding to the mobile device. Desktop information is to be presented on a display screen of the mobile device for user's reference or use. In an example, desktop information includes but is not limited to system notification information of the mobile device, in-app notification information or other information generated in the applications installed on the mobile device, application information pushed by a third party server, etc. In some embodiments, at least a part of the desktop information may be selected and determined based on the user profile model of the user of the mobile device. In some embodiments, a user profile may include at least one set of variables used to describe user data. In some embodiments, the variables used to describe user data may be represented in user tags. In some embodiments, the variables used to describe user data may include at least one of numerical variables and type variables. In some embodiments, a user profile may be applied to applications providing service to the user based on the personality of the user, such as applications providing personalized recommendations, advertisement systems, activity promotions, contents recommendations, interest preferences, etc. A user profile may be derived from existing data. In an example, user identification information may be used to accurately derive the gender tag, place of birth tag, date of birth tag of the user. Recipient information regarding online shopping in connection with machine learning may be used to derive the gender of the buyer in a probability. In an example, Jianguo or Albert is possibly a man and corresponds to a male tag, while Cuihua or Jessica is possibly a woman and corresponds to a female tag. When it is necessary to select a group of users for fine operation or accurate information push, a particular group of people may be screened out according to the user profile for corresponding operations. In some embodiments, one or more pieces of desktop information may be selected and determined based on the user profile model in connection with an implicit semantic recommendation model.

In some embodiments, user tags may be acquired through machine learning on user identification information, browsing or operation records of the user, system settings of the user, mobile device related information (e.g., geographic location, network status, etc.), current time information, and the like. Machine learning may be performed in various ways, for example, machine learning may be performed based on logistic regression, a decision tree, a Bayesian model, KNN, a support vector machine, clustering (such as K-Means), a hidden Markov model, etc., or based on a supervised/unsupervised neural network, a deep neural network, and the like. In addition, user tags may be acquired from popular tags crawled from the web and keywords extracted from operation contents. In an example, some examples of popular tags may include “online shopping expert” tag acquired from the historic online shopping records, “digital enthusiast” tag acquired from news browsing records or webpage browsing records. Operation contents include but are not limited to audios, texts, and videos. All of or a portion of the desktop information presented on the desktop of the mobile device may be selected and acquired in the above mentioned manner. In an example, the desktop information selected and acquired is presented on a preset area of the desktop while fixed contents are presented on other areas, such as clock information, etc.

Here, the desktop information includes but is not limited to: an application launch icon for starting the application in response to a user's running instruction, application interaction information for implementing application functions, application notification information for presenting information of the application for user's reference or decision which is generated in the foreground or background, application push information pushed to the application from a server which provides prompts to the user, application update information on application iterations or updates, other information in the application (e.g., information acquired through corresponding functional entry in the application).

Of course, it can be understood by those skilled in the art that the above mentioned machine learning methods or desktop information is merely an example. Other existing machine learning methods or desktop information or those that may appear in the future fall within the protection scope of the present application and are incorporated herein by reference if applicable to the present application.

At step S12, a current desktop of the mobile device is presented according to the one or more pieces of desktop information. The one or more pieces of desktop information may be acquired in a manner that includes but is not limited to: selected and acquired locally on the mobile device; selected and acquired at a remote device, such as a network device at clouds or a network device communicates with the mobile device; or selected and acquired both locally on the mobile device and at a remote device.

In some embodiments, at step S11, the mobile device determines one or more pieces of desktop information from one or more pieces of candidate desktop information of the mobile device based on a user profile model of a corresponding user of the mobile device. In an example, one or more pieces of candidate desktop information may be selected locally on the mobile device or at a remote device (e.g., a network device at clouds or a network device communicates with the mobile device) to acquire desktop information for presentation on the mobile device. In some non-limiting embodiments, the mobile device may acquire the selected desktop information in one of the following ways:

a. a remote device sending candidate desktop information to the mobile device and the mobile device selecting from these candidate desktop information;

b. a remote device selecting from the candidate desktop information and sending the selected desktop information to the mobile device;

c. a remote device selecting from the candidate desktop information from the remote device and sending the selected desktop information to the mobile device, and the mobile device selecting from the candidate desktop information local to the mobile device. In some embodiments, selected candidate desktop information from the remote device and the mobile device may be presented on different locations of the mobile device respectively.

d. a remote device selecting from the candidate desktop information from the remote device and sending the selected desktop information to the mobile device, and the mobile device selecting from the selected candidate desktop information from the remote device and local desktop information from the mobile device to acquire further selected desktop information.

Of course, it can be understood by those skilled in the art that the above mentioned operation of selecting is merely an example. Other existing operations of selecting or those that may appear in the future fall within the protection scope of the present application and are incorporated herein by reference, if applicable to the present application. The operation of selecting on the candidate desktop information may be performed based on a user profile model. In some embodiments, the operation of selecting may be performed based on a degree of user's interest on or need for candidate desktop information of different types or with different contents. For example, a degree of user's interest/need may be represented in probability. The operation of selecting may be performed based on a combination of a degree of user's interest on or need for candidate desktop information, e.g., a weighted sum of both. The operation of selecting on desktop information may be implemented through machine learning.

In one embodiment, at step S11, the mobile device determines one or more pieces of desktop information from one or more pieces of candidate desktop information of the mobile device based on the user profile model of the corresponding user of the mobile device in connection with device related information of the mobile device. On the basis of implementing the selecting on desktop information based on the user profile model of the user, in connection with device related information of the user's mobile device, the selecting on desktop information may be enhanced by correcting the status of use of the mobile device by the current user, thereby presenting desktop information currently needed by the user more accurately. In some embodiments, device related information of the mobile device is used to characterize the current state of the mobile device. Sometimes it may be used to characterize an activity state to be entered by the user.

In some embodiments, device related information of the mobile device includes at least one of:

a. calendar information of the mobile device, e.g., user's calendar recorded in a calendar application of the mobile device, including user's activity time, place to go, a transportation vehicle to be taken, etc. Of course, other information may also be included, which will not be listed here one by one;

b. network connection status information of the mobile device, e.g., a Wi-Fi hotspot currently connected by the mobile device or mobile data connection information;

c. location information of the mobile device, which may be determined by for example a GPS reception module or by a wireless connection, e.g., a Wi-Fi connection, mobile data connection, etc.;

d. historic activity information of the mobile device, such as historic location information and network connection status information of the mobile device in a recent time period;

e. gesture information of the mobile device, which may be determined by for example a gyro to determine a current gesture of the mobile device, e.g., a pitch, a placement orientation, etc. of the mobile device. Gesture information may be used to assist determining the state of use of the mobile device. The mobile device may not be used when placed flat. The mobile device may be held up or in use when it is placed with an angle to the horizontal plane.

Of course, it can be understood by those skilled in the art that the above mentioned device related information is merely an example. Other existing device related information or those that may appear in the future fall within the protection scope of the present application and are incorporated herein by reference, if applicable to the present application. One simple example of application device related information is that a plan of taking a subway is set in the user's calendar. When the user takes a subway as planned and the mobile device detects that the user has arrived at the destination station and exited, information on bus transfer or shared bikes available nearby will be presented to the user.

In some embodiments, the one or more pieces of candidate desktop information includes at least one of: candidate desktop information provided by a corresponding network device; candidate desktop information local to the mobile device.

When the candidate desktop information includes the candidate desktop information provided by a network device corresponding to the mobile device, a flowchart of a method for providing a desktop according to some embodiments is illustrated in FIG. 2. At step S21, the network device determines one or more pieces of candidate desktop information corresponding to the mobile device from an application message pushed by an application server. At step S22, the network device sends the one or more pieces of candidate desktop information to the mobile device. When the mobile device receives the candidate desktop information sent by the network device, at step S11, the mobile device determines one or more pieces of desktop information from one or more pieces of candidate desktop information of the mobile device based on a user profile model of a corresponding user of the mobile device. The network device may return corresponding desktop information to the mobile device based on a desktop update request initiated by the mobile device. The network device may also push corresponding desktop information to the mobile device directly. In an example, desktop information may be pushed at regular intervals or desktop information push may be triggered after the desktop information is updated. In some embodiments, the network device may determine the candidate desktop information based on a big data model. The big data model includes, but is not limited to, a logistic regression model, a decision tree model, a Bayesian model, a KNN model, a support vector machine model, a clustering (such as K-Means) model, a hidden Markov model, etc., or based on supervised/unsupervised neural networks, deep neural network models. The big data model may also include any combination of the above models. Of course, it may be appreciated by those skilled in the art that the above mentioned big data model is merely an example. Other existing big data models or those that may appear in the future fall within the protection scope of the present application and are incorporated herein by reference if applicable to the present application.

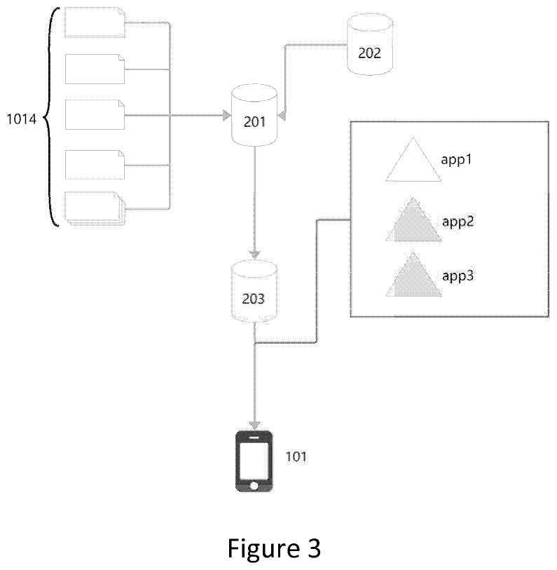

Referring to FIG. 3, in some embodiments, the network device includes a computing server 201, a data server 202 and a push server 203. The mobile device 101 sends a desktop update request to the cloud. The desktop update request contains mobile device related information 1014, for example, application usage information such as time of use, location of use, number of use, frequency, and the like of the applications on the mobile device 101, current state of the device (e.g., a connected wifi, geographic location information of the device acquired by a GPS module, device motion status acquired by an accelerator module, device gesture acquired by a gyro, etc.), and the like. These information is input to the computing server 201 as input. A user data model of the user corresponding to the mobile device 101 is also input to the computing server 201 from the data server 202. The computing server 201 applies the input information to the user data model, acquires one or more pieces of desktop information, sorts the desktop information based on a user profile model, and sends the one or more pieces of desktop information along with the sorting information to the push server 203. The push server 203 sends the desktop information along with the sorting information (e.g., in a priority) to the mobile device 101 for presentation on the desktop of the mobile device 101. Further, the mobile device 101 also receives push messages sent by a third server corresponding to various applications, for example, app1, app2, app3. The mobile device 101 sorts the desktop information sent by the push server 203 and the application push messages (for example reorder the information and messages based on the time of update) and presents sorted desktop information. The third party server includes but is not limited to: a server provided by a device manufacturer, e.g., an iCloud server provided by Apple Inc., a server provided by an application developer, e.g., a server for providing services related to applications providing Wi-Fi master key. The data server 202 records historic behavior of the user on the internet to provide a more accurate profile of the user. In addition, the computing server 201, the data server 202, and the push server 203 may be combined or further decomposed into more servers, as long as the corresponding functions can be performed.

Of course, the desktop information may come from the network device as well as the mobile device. In an example, the mobile device selects and/or sorts the desktop information generated locally on the mobile device and/or sent by the network device based on a local user data model. In addition, the desktop information may also be based on candidate desktop information from the network device (direct push or push after selecting and/or sorting) and the mobile device, and is presented after selecting and/or sorting (e.g., based on a user data model local to the mobile device) locally at the mobile device.

In one embodiment, the above method for providing a desktop further comprises step S23 (not shown). At step S23, the network device screens the one or more pieces of candidate desktop information based on a user profile model of a corresponding user of the mobile device. In an example, a fixed number of pieces of desktop information with the highest priority is screened out according to the probability of presentation of the desktop information determined based on the user profile model, or desktop information with a priority reaching a preset threshold is screened out. Then at step S22, the network device sends the screened one or more pieces of candidate desktop information to the mobile device.

In one embodiment, at step S23, the network device screens the one or more pieces of candidate desktop information based on the user profile model of the corresponding user of the mobile device and application related information corresponding to the candidate desktop information. In some embodiments, the application related information may include at least one of: frequency of use information of an application corresponding to the candidate desktop information on the mobile device; accumulated time of use information of an application corresponding to the candidate desktop information on the mobile device; the time of the latest use information of an application corresponding to the candidate desktop information on the mobile device; generation time information of the candidate desktop information.

In some embodiments, when determining one or more pieces of desktop information to be presented on the desktop of the mobile device, the mobile device may select one or more pieces of desktop information for presentation on its desktop according to its candidate desktop information. In an example, based on the frequency of use information, the accumulated time of use information, the time of the latest use information, the generation time information etc., of the corresponding application, a weighted presentation priority is sorted, or these information is input into a corresponding user profile model for sorting information or is sorted according to only one kind of these information (for example, the frequency of use information). Of course, it can be understood by those skilled in the art that the above mentioned method of sorting is merely an example. Other existing methods of sorting or those that may appear in the future fall within the protection scope of the present application and are incorporated herein by reference if applicable to the present application.

In some embodiments, the user profile model is trained based on an operation information of the user on the mobile device. The training process of the user profile model may be performed by the mobile device locally, or may be performed by other devices at clouds and the user profile model is then distributed to the mobile device. Or the training process of the user profile model is performed by the mobile device and other devices at clouds together. In an example, other devices at clouds form basic model parameters of the user profile model and the mobile device further determines other model parameters of the user profile model on such basis. The operation information of the user on the mobile device includes but is not limited to: an operation of the user viewing desktop information, an operation of the user opening an application, an operation of the user using an application, an operation of the user viewing system notification or a third party push message, etc. It can be understood by those skilled in the art that the above mentioned operation information is merely an example. Other existing operation information or that may appear in the future fall within the protection scope of the present application and are incorporated herein by reference, if applicable to the present application.

In some embodiments, the one or more pieces of desktop information includes a first set of desktop information, wherein the number of the first set of desktop information equals to or is less than a predetermined number, and the first set of desktop information is determined by the mobile device locally or is provided by a corresponding network device. In an example, a first set of desktop information is determined from among one or more pieces of desktop information acquired locally at the mobile device and/or from the corresponding network device. The number of piece of information in the first set of desktop information is no more than a predetermined number. In an example, the resource location for presenting the first set of desktop information has the predetermined number. The system determines one or more pieces of desktop information, the number of which is no more than the predetermined number, according to the priority of the desktop information from one or more pieces of desktop information, and applies for a corresponding resource location in these resource locations for presenting a first set of desktop information qualified for the priority condition to the user. In some embodiments, the priority condition includes but is not limited to: the priority of a piece of desktop information is higher than a priority threshold and/or the priority of a piece of desktop information is higher than the priorities of other desktop information.

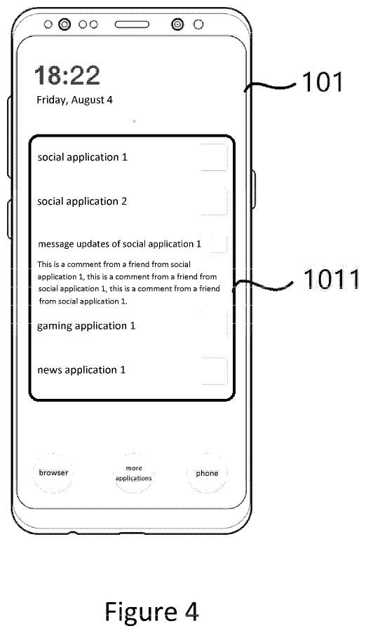

A desktop schematic diagram of some embodiments of a mobile device 101 is illustrated with reference to FIG. 4. The desktop contains a card 1011 for presenting desktop information. The card 1011 contains a predetermined number (e.g., 5) of presentation resource locations for presenting desktop information, including application launch icons (e.g., a launch icon for social application 1 for starting the social application 1 upon clicking), social messages in a social application or a social module of other applications (e.g., push messages from social application 1 or social application 2, message updates on friends interaction from social application 1), message updates of other software applications (e.g., a gaming application 1, a news application 1, etc.). The desktop information may be selected and sorted based on the user profile model by the mobile device. Several pieces of desktop information with the highest priority (the number of the desktop information is no more than the predetermined number, e.g., 5) is selected and presented. The basis for sorting includes but is not limited to application related information of corresponding applications, such as frequency of use of the corresponding application on the mobile device in a period of time, accumulated time of use of the corresponding application on the mobile device, and the time of latest use information of the corresponding application on the mobile device, desktop information generation time, etc. Instant messages, social messages, and application content updates may be presented according to the sorting result of the applications. In some embodiments, multiple pieces of desktop information of one application is located in adjacent presentation resource locations and is sorted in order of time. In some embodiments, multiple pieces of desktop information from multiple applications is mixed and sorted in order of time. In this case, multiple pieces of desktop information of one application may be located in presentation resource locations that are not adjacent.

In some embodiments, the current desktop further includes icons for accessing other applications. When the mobile device receives a trigger operation on the button for accessing other applications, the mobile device presents an application access icon for one or more applications in the mobile device on the current desktop. In an example, when the user needs to browse a list of all the applications installed on the current mobile device, the user clicks the “Home” or “More Applications” button on the desktop of the mobile device. The mobile device presents a list of access icons for the applications installed on the mobile device on the current desktop. The user may browse the applications installed on the current mobile device through the list of application access icons, or the user may also access application related information of a corresponding application through the list of application access icons, or the user may start a corresponding application. The list of application access icons may contain application access icons of applications corresponding to the selected desktop information, or may exclude one or more of the application access icons of applications corresponding to the selected desktop information.

In some embodiments, step S12 includes sub-step S121 (not shown) and sub-step S122 (not shown). At sub-step S121, a current desktop of the mobile device is generated according to the one or more pieces of desktop information. At sub-step S122, the current desktop is presented. In an example, the mobile device generates and presents a current desktop according to the one or more pieces of desktop information for presentation acquired in step S11. The current desktop includes the above mentioned one or more pieces of application information. In some embodiments, generating the current desktop may be based on a trigger operation of the user. Of course, the current desktop including the desktop information may be generated in advance, for example, generated in advance locally at the mobile device for invoke and presentation. Or the current desktop may be generated in advance at a network device. For example, a network device pushes desktop information regularly, or pushes desktop information to the mobile device when the desktop information (e.g., of an application) on the desktop changes, or the network device returns a corresponding current desktop including one or more pieces of desktop information based on a desktop presentation request from the mobile device. Of course, the current desktop of the mobile device may further include other elements, such as static or dynamic background pictures, controls (e.g., clock) that are displayed at all times, etc.

In some embodiments, the mobile device detects whether a desktop presentation trigger condition for desktop presentation on the mobile device is satisfied. When the desktop presentation trigger condition is satisfied, at step S11, the mobile device acquires one or more pieces of desktop information of the mobile device. The one or more pieces of desktop information may be selected and determined based on a user profile model of a user corresponding to the mobile device. According to some embodiments of the present application, the desktop presentation trigger condition includes at least one of: the mobile device is unlocked successfully, the mobile device detects a back to desktop operation of the user, the mobile device detects a desktop refresh operation of the user. Of course, it can be understood by those skilled in the art that the above mentioned desktop presentation trigger condition is merely an example. Other existing desktop presentation trigger conditions or those that may appear in the future fall within the protection scope of the present application and are incorporated herein by reference, if applicable to the present application.

The following description continues with the trigger condition that the mobile device is unlocked successfully as an example. In an example, when the mobile device is unlocked via passwords, it is detected whether the character sequence input in the password input box by the user matches a preset character sequence. In another example, when the mobile device is unlocked via gestures, it is detected whether the gesture input by the user (e.g., a trajectory on the touch screen by user's finger) matches a preset gesture. In a further example, when the mobile device is unlocked via fingerprints, it is detected whether the fingerprint information input by the user matches preset fingerprint information. When the mobile device is unlocked by the user successfully, the mobile device presents a desktop (a graphical user interface) on the display screen. The graphical user interface contains one or more pieces of desktop information, for example, including but not limited to, application launch icons, application interaction information, application notification information, application push information, application update information, or other information in the applications. The information is screened according to the user profile model of the user and is sorted and presented. Taking the application launch icon as an example, the basis for sorting of the application launch icons includes, but is not limited to, frequency of use of the corresponding application on the mobile device in a period of time, accumulated time of use of the corresponding application on the mobile device, and the time of the latest use of the corresponding application on the mobile device, etc. Of course, it may be appreciated by those skilled in the art that the above mentioned method of unlocking and basis for sorting is merely an example. Other existing methods of unlocking and basis for sorting or those that may appear in the future fall within the protection scope of the present application and are incorporated herein by reference if applicable to the present application. For example, the user may unlock the mobile device via biometric information such as voiceprint and iris information. Application information includes application push information, interaction information, notification information, etc. The mobile device sorts and presents the information according to the generation time.

In some embodiments, at step S12, the mobile device presents one or more pieces of desktop information on the current desktop of the mobile device according to time property information of the desktop information. In an example, the selected desktop information according to the user profile model of the user may be sorted and presented according to the update time of the desktop information, the local generation time at the mobile device, the arrival time of the desktop information at the mobile device sent from the network device. For example, the desktop information which is recently generated or arrives has a higher priority than other desktop information for presentation. In some embodiments, the operation of sorting the desktop information may be performed in step S11. In some embodiments, the operation of sorting the desktop information may be performed in step S12. In some embodiments, step S11 and step S12 both include an operation of sorting the desktop information. Sorting the desktop information according to time property information provides the latest news to the user for the user to make a timely decision or feedback, thereby improving the operation efficiency of the user and enhancing the user experience.

In one embodiment, at step 12, the mobile device presents the one or more pieces of desktop information on the current desktop of the mobile device according to the time property information of the desktop information and the desktop presentation mode of the mobile device. Here, the desktop presentation mode may include various ways, including but not limited to: the current desktop contains several presentation resource locations and various applications apply to the system for the presentation resource locations for desktop information presentation according to the presentation priority (e.g., sorted in time dimension) of their application information, or the application information are presented sequentially or in combination on the current desktop according to the presentation priority (e.g., sorted in time dimension). In some embodiments, the mobile device determines the desktop presentation mode of the mobile device according to the one or more pieces of desktop information. Then at step S12, the mobile device presents the one or more pieces of desktop information on the current desktop of the mobile device according to the time property information of the desktop information and the desktop presentation mode. In an example, the desktop of the mobile device is provided with one or more cards for presenting desktop information in different types. The mobile device determines the desktop information to be presented in one or more cards, or the size, number or relative location of these cards according to the number or type of the acquired one or more pieces of desktop information.

In some embodiments, the desktop presentation mode of the mobile device contains a plurality of cards of different types. At step S11, the mobile device acquires its one or more pieces of desktop information. The one or more pieces of desktop information may be selected and determined based on a user profile model of a user corresponding to the mobile device. And the desktop information matches one of card type information in the desktop presentation mode. In an example, when the one or more pieces of desktop information is information related to social applications (e.g., application launch icons for social applications, instant messages of social applications, comments of other users related to the user of the mobile device, etc.), the desktop information matches “social applications” card type in the desktop presentation mode. Correspondingly, the desktop information is presented in a card of “social applications”.

In some embodiments, the presentation forms for one or more pieces of desktop information on the current desktop include at least one of:

a. if the desktop presentation mode contains one card, the one or more pieces of desktop information is arranged in the card according to the time property information of the desktop information;

b. if the desktop presentation mode contains a plurality of cards of different types, the one or more pieces of desktop information is respectively presented in at least one of the cards according to the type of the desktop information or the type of the application to which the desktop information belonged, and multiple pieces of desktop information in one card is arranged according to the time property information of the desktop information;

c. the desktop presentation mode contains a plurality of cards of different types, and the one or more pieces of desktop information is respectively presented in at least one of the cards according to the frequency of use of the application to which the desktop information belonged, and multiple pieces of desktop information in one card is arranged according to the time property information of the desktop information;

d. if the desktop presentation mode contains a timeline, the one or more pieces of desktop information is arranged along the timeline according to the time property information of the desktop information.

In embodiments where the desktop presentation mode contains one card and the one or more pieces of desktop information is arranged in the card according to the time property information of the desktop information, a schematic diagram of the desktop of the mobile device 101 is illustrated with reference to FIG. 4. The desktop contains a card 1011 for presenting desktop information. The desktop information in the card 1011 is sorted in time dimension. The desktop information includes application launch icons (e.g., launch icon for social application 1 for starting the social application 1 upon clicking), social messages in social applications (e.g., social application 1, social application 2) or social modules in other software, message updates of other application software (e.g., gaming application 1, news application 1, etc.). Taking application launch icon as an example, the application launch icons are presented in an order of event property. The basis for sorting includes, but is not limited to, frequency of use of the corresponding application on the mobile device in a period of time, accumulated time of use of the corresponding application on the mobile device, and the time of the latest use of the corresponding application on the mobile device, etc. Instant messages, social messages, and application content updates may be presented according to the sorting result of the applications. In some embodiments, multiple pieces of desktop information of one application may be located in adjacent presentation resource locations respectively. And the multiple pieces of desktop information of one application is presented in order of time. In some embodiments, multiple pieces of desktop information from multiple applications is mixed and sorted in order of time. In this case, multiple pieces of desktop information of one application may be located in presentation resource locations that are not adjacent. In addition, related contents in the applications may be refreshed and presented when the mobile device detects that a desktop trigger condition is satisfied. With reference to FIG. 4 as an example, social application 1 message updates are acquired and presented after it is detected that the user clicks the “Home” button on the screen of the mobile device 101 and push contents of social application 1 are refreshed in background. Of course, the way of arrangement of desktop information includes a horizontal arrangement or mere icon/text display in addition to the vertical arrangement illustrated in FIGS. 4, 5, 6 and 7. It may be understood by those skilled in the art that the above mentioned way of arrangement is merely an example. Other existing ways of arrangement or those that may appear in the future fall within the protection scope of the present application and are incorporated herein by reference if applicable to the present application. For example, a horizontal arrangement and a vertical arrangement may be combined, or a circular arrangement may be possible.

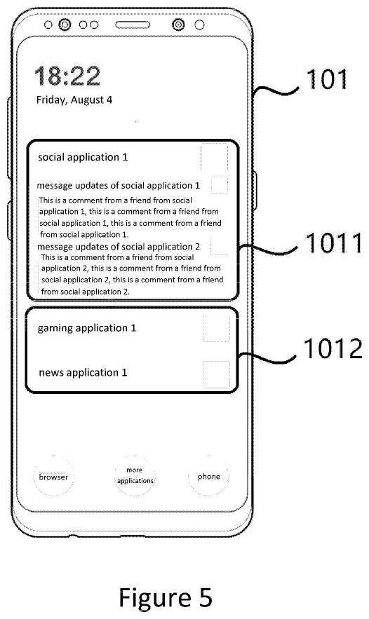

In embodiments where the desktop presentation mode contains a plurality of cards of different types and the one or more pieces of desktop information is respectively presented in at least one of the cards according to the type of the desktop information or the type of the application to which the desktop information belonged, and multiple pieces of desktop information in one card is arranged according to the time property information of the desktop information, a desktop schematic diagram of the mobile device 101 is illustrated with reference to FIG. 5. The desktop contains two (may be more or fewer) cards: a first card 1011 and a second card 1012 for presenting corresponding desktop information in different types according to the application type to facilitate viewing and use by the user. In an example, when the desktop information is presented according to the application type of corresponding applications and the first card 1011 corresponds to “social applications” and the second card 1012 corresponds to “other applications”, the desktop information of social application 1 and social application 2 (including the launch icon of social application 1, message updates of social application 1, message updates of social application 2) is presented in the first card 1011 which is easier for the user to notice. And the launch icon of social application 1, message updates of social application 1, and message updates of social application 2 are sorted according to their time property. Desktop information of other applications (e.g., the application launch icon of gaming application 1, and the launch icon of a news application) is presented in the second card 1012.

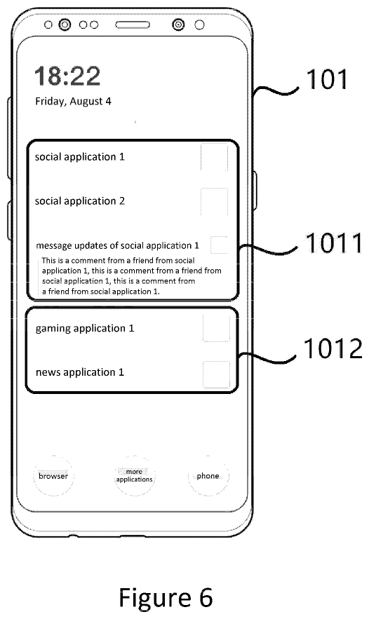

In embodiments where the desktop presentation mode contains a plurality of cards of different types and the one or more pieces of desktop information is respectively presented in at least one of the cards according to the frequency of use of the application to which the desktop information belonged, and multiple pieces of desktop information in one card is arranged according to the time property information of the desktop information, a desktop schematic diagram of the mobile device 101 is illustrated with reference to FIG. 6. The desktop contains two (may be more or fewer) cards: a first card 1011 and a second card 1012 for presenting corresponding desktop information according to frequency of use of different applications to facilitate viewing and use by the user. In an example, desktop information corresponding to social applications with higher frequency of use by the user is presented in the first card 1011 which is easier for the user to notice. Desktop information corresponding to other applications is presented in the second card 1012. The desktop information in the first card 1011 and the second card 1012 is arranged according to the event property.

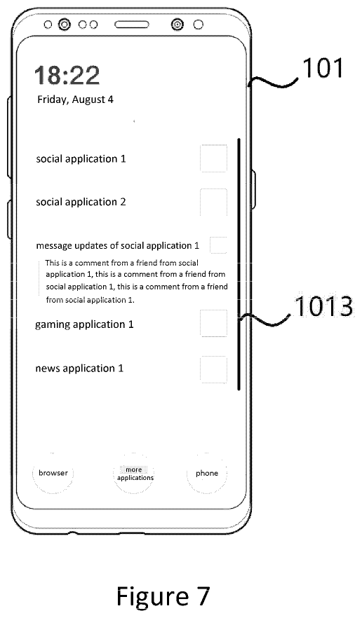

In embodiments where the desktop presentation mode contains a timeline and the one or more pieces of desktop information is arranged along the timeline according to the time property information of the desktop information, a schematic diagram of the desktop of the mobile device 101 is illustrated with reference to FIG. 7. The desktop is presented with desktop information corresponding to several applications and a timeline 1013 (explicitly or implicitly presented). Launch icons of applications with higher frequency of use and application push messages received later may be presented in earlier locations of the timeline 103.

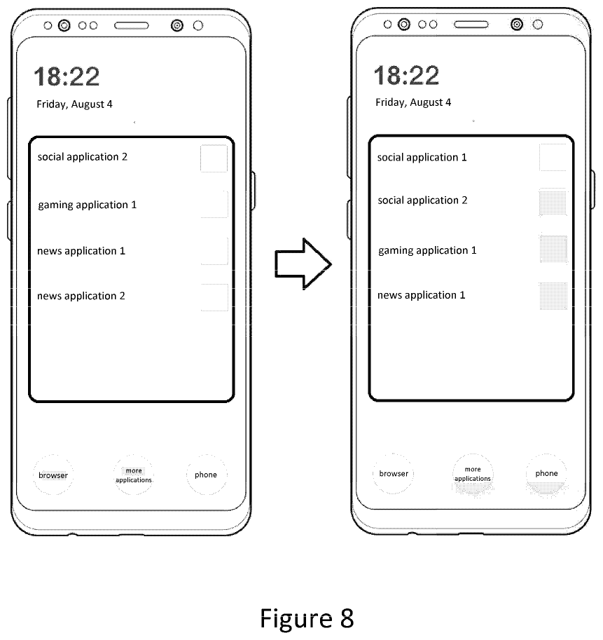

In some embodiments, at step S12, the mobile device updates the current desktop of the mobile device according to the one or more pieces of desktop information acquired in step S11. Before step S11, the mobile device has presented a desktop with desktop information and actively or passively acquires one or more pieces of updated desktop information in step S11. In an example, the mobile device acquires one or more pieces of desktop information according to a desktop update instruction from the user. Or the mobile device acquires one or more pieces of desktop information locally and/or from a network device regularly. Or the mobile device receives one or more pieces of desktop information pushed by the network device. With reference to FIG. 8, some embodiments where the mobile device updates the current desktop according to one or more pieces of desktop information are illustrated. The mobile device 101 has presented a desktop for the user. The desktop includes application launch icons “social application 2”, “gaming application 1”, “news application 1” and “news application 2”. The mobile device 101 then receives updated desktop information pushed by the network device. The desktop information includes application entries “social application 1”, “social application 2”, “gaming application 1”, and “news application 1”. The mobile device 101 updates the current desktop according to the desktop information and provides the user with desktop information that best suits his/her needs. In some embodiments, the network device may only push the update contents of the current desktop, for example, desktop information to be added or deleted. Continued with FIG. 8 as an example, the mobile device 101 updates the current desktop based on an addition instruction of application launch icon “social application 1” and a deletion instruction of application launch icon “news application 2” pushed by the network device.

According to some embodiments of the present application, a method for providing a desktop at a network device is provided. The method comprises step S21 and step S22. At step S21, the network device determines one or more pieces of candidate desktop information corresponding to the mobile device from an application message pushed by an application server. At step S22, the network device sends the one or more pieces of candidate desktop information to the mobile device.

In one embodiment, the above method for providing a desktop at a network device further comprises step S23 (not shown). At step S23, the network device screens the one or more pieces of candidate desktop information based on a user profile model of a user corresponding to the mobile device. At step S22, the network device sends the screened one or more pieces of candidate desktop information to the mobile device.

In one embodiment, at step S23, the network device screens the one or more pieces of candidate desktop information based on the user profile model of the user corresponding to the mobile device and application related information corresponding to the candidate desktop information.

In one embodiment, in the above method for providing a desktop at a network device, the application related information includes at least one of:

frequency of use information of an application corresponding to the candidate desktop information on the mobile device;

accumulated time of use information of an application corresponding to the candidate desktop information on the mobile device;

the time of the latest use information of an application corresponding to the candidate desktop information on the mobile device;

generation time information of the candidate desktop information at a corresponding application server.

According to some embodiments of the present application, a method for providing a desktop is provided. The method comprises: determining, by a network device, one or more pieces of candidate desktop information corresponding to a mobile device from an application message pushed by an application server, and sending the one or more pieces of candidate desktop information to the mobile device; determining, by the mobile device, one or more pieces of desktop information from the one or more pieces of candidate desktop information based on a user profile model of a corresponding user, wherein the one or more pieces of candidate desktop information includes candidate desktop information provided by a corresponding network device; presenting, by the mobile device, a current desktop of the mobile device according to the one or more pieces of desktop information.

According to some embodiments of the present application, a mobile device for providing a desktop is provided. The mobile device comprises: a processor; and a memory configured to store computer executable instructions, wherein the executable instructions, when executed, cause the processor to: acquire one or more pieces of desktop information of the mobile device, wherein at least one of the one or more pieces of desktop information may be selected and determined based on a user profile model of a corresponding user of the mobile device; present a current desktop of the mobile device according to the one or more pieces of desktop information.

According to some embodiments of the present application, a network device for providing a desktop is provided. The network device comprises: a processor; and a memory configured to store computer executable instructions, wherein the executable instructions, when executed, cause the processor to: determine one or more pieces of candidate desktop information corresponding to a mobile device from an application message pushed by an application server; send the one or more pieces of candidate desktop information to the mobile device.

According to some embodiments of the present application, a computer readable medium comprising instructions is provided, wherein the instructions, when executed, cause a system to: acquire one or more pieces of desktop information of the mobile device, wherein at least one of the one or more pieces of desktop information may be selected and determined based on a user profile model of a corresponding user of the mobile device; present a current desktop of the mobile device according to the one or more pieces of desktop information.

According to some embodiments of the present application, a computer readable medium comprising instructions is provided, wherein the instructions, when executed, cause a system to: determine one or more pieces of candidate desktop information corresponding to a mobile device from an application message pushed by an application server; send the one or more pieces of candidate desktop information to the mobile device.

It should be noted that the present application may be implemented in software and/or a combination of software and hardware, for example, by using an application specific integrated circuit (ASIC), a general purpose computer, or any other similar hardware device. In one embodiment, the software program of the present application may be executed by a processor to implement the steps or functions described above. Likewise, the software programs (including related data structures) of the present application may be stored in a computer readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application may be embodied as a computer program product, such as computer program instructions, when executed by a computer, may invoke or provide a method and/or technical solution in accordance with the present application. It is to be understood by those skilled in the art that computer program instructions exist in a computer-readable medium in a form of including, but not limited to, a source file, an executable file, an installation package file, and the like. Correspondingly, the manner in which a computer program instruction is executed by a computer includes, but is not limited to, the computer directly executing the instruction, or the computer compiling the instruction and then executing the corresponding compiled program, or the computer reading and executing the instruction, or the computer reading and installing the instruction and then executing the corresponding post-installation program. Here, the computer-readable medium may be any available computer-readable storage medium or communication medium that may be accessed by a computer.

Communication medium includes medium by which communication signals which include, for example, computer-readable instructions, data structures, program modules, or other data, are transmitted from one system to another. Communication medium may include guided transmission medium (such as cables and wires (e.g., fiber optics, coaxial, etc.)) and wireless (non-conductive transmission) medium that may propagate energy waves, such as sound, electromagnetic, RF, microwave, and infrared. Computer readable instructions, data structures, program modules or other data may be embodied, for example, as a modulated data signal in a wireless medium, such as a carrier wave or a similar mechanism such as being embodied as part of a spread spectrum technology. The term “modulated data signal” refers to a signal whose one or more characteristics are altered or set by encoding information in the signal. Modulation may be analog, digital, or may be hybrid modulation techniques.

By way of example and not limitation, computer-readable storage medium may include volatile and non-volatile, removable and non-removable medium implemented by any method or technology used to store information such as computer readable instructions, data structures, program modules or other data. For example, computer-readable storage medium includes, but is not limited to, volatile memory such as random access memory (RAM, DRAM, SRAM); and non-volatile memory such as flash memory, various read-only memories (ROM, PROM, EPROM, EEPROM), magnetic and ferromagnetic/ferroelectric memory (MRAM, FeRAM); and magnetic and optical storage devices (hard disk, cassette, CD, DVD); or other existing or known medium or any medium to be developed in the future that may store computer-readable information/data for use by computer systems.

Herein, an embodiment in accordance with the present application includes an apparatus including a memory for storing computer program instructions and a processor for executing program instructions, wherein when the computer program instructions are executed by the processor, triggering the apparatus to operate the aforementioned methods and/or technical solutions in accordance with various embodiments of the present application.

For those skilled in the art, it is apparent that the present application is not limited to the details of the above-mentioned exemplary embodiments, and the present application may be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. A plurality of units or means stated in the apparatus claims may also be implemented by one unit or means by means of software or hardware. The terms first and second and the like are used to represent names and do not represent any particular order.

What is claimed is:

1. A method for providing a desktop at a mobile device, comprising:
acquiring one or more pieces of desktop information of the mobile device, wherein at least one of the one or more pieces of desktop information is selected and determined based on a user profile model of a corresponding user of the mobile device; and
presenting a current desktop of the mobile device according to the one or more pieces of desktop information.

2. The method according to claim 1, wherein the step of acquiring one or more pieces of desktop information of the mobile device, comprising:
determining one or more pieces of desktop information from one or more pieces of candidate desktop information of the mobile device based on the user profile model of the corresponding user of the mobile device.

3. The method according to claim 2, wherein the step of determining one or more pieces of desktop information from one or more pieces of candidate desktop information of the mobile device based on the user profile model of the corresponding user of the mobile device, comprising:
determining one or more pieces of desktop information from one or more pieces of candidate desktop information of the mobile device based on the user profile model of the corresponding user of the mobile device in connection with device related information of the mobile device.

4. The method according to claim 3, wherein the device related information of the mobile device includes at least one of:
calendar information of the mobile device;
network connection status information of the mobile device;
location information of the mobile device;
historic activity information of the mobile device; and
gesture information of the mobile device.

5. The method according to claim 2, wherein the one or more pieces of candidate desktop information includes at least one of:
candidate desktop information provided by a corresponding network device; and
candidate desktop information local to the mobile device.

6. The method according to claim 1, wherein the one or more pieces of desktop information includes a first set of desktop information, a number of the first set of desktop information equals to or is less than a predetermined number, the first set of desktop information is determined by the mobile device locally or is provided by a corresponding network device.

7. The method according to claim 1, wherein the current desktop further includes button for accessing other applications;
wherein the method further comprising:
presenting an application access icon for one or more applications in the mobile device on the current desktop when receiving a trigger operation on the button for accessing other applications.

8. The method according to claim 1, wherein the step of presenting the current desktop of the mobile device according to the one or more pieces of desktop information, comprising:
generating the current desktop of the mobile device according to the one or more pieces of desktop information; and
presenting the current desktop.

9. The method according to claim 1, wherein the method further comprising:
detecting whether a desktop presentation trigger condition for presenting a desktop on the mobile device is satisfied, wherein the desktop presentation trigger condition includes at least one of: the mobile device being unlocked successfully; the mobile device detecting a back to desktop operation by the user; and the mobile device detecting a desktop refresh operation by the user;
wherein the step of acquiring one or more pieces of desktop information of the mobile device, comprising:
acquiring one or more pieces of desktop information of the mobile device when the desktop presentation trigger condition is satisfied, wherein the one or more pieces of desktop information is selected and determined based on the user profile model of the corresponding user of the mobile device.

10. The method according to claim 1, wherein the step of presenting the current desktop of the mobile device according to the one or more pieces of desktop information, comprising:
presenting the one or more pieces of desktop information on the current desktop of the mobile device according to time property information of the desktop information.

11. The method according to claim 10, wherein the step of presenting the one or more pieces of desktop information on the current desktop of the mobile device according to the time property information of the desktop information, comprising:
presenting the one or more pieces of desktop information on the current desktop of the mobile device according to the time property information of the desktop information and desktop presentation mode of the mobile device.

12. The method according to claim 11, wherein the method further comprising:
determining the desktop presentation mode of the mobile device according to the one or more pieces of desktop information;
wherein the step of presenting the current desktop of the mobile device according to the one or more pieces of desktop information, comprising:
presenting the one or more pieces of desktop information on the current desktop of the mobile device according to the time property information of the desktop information and the desktop presentation mode.

13. The method according to claim 11, wherein the desktop presentation mode of the mobile device contains a plurality of cards of different types;
wherein the step of acquiring one or more pieces of desktop information of the mobile device, wherein at least one of the one or more pieces of desktop information is selected and determined based on the user profile model of the corresponding user of the mobile device, comprising:
acquiring one or more pieces of desktop information of the mobile device, wherein the one or more pieces of desktop information is selected and determined based on the user profile model of the corresponding user of the mobile device and the desktop information matches one of card types information of the desktop presentation mode.

14. The method according to claim 10, wherein presentation forms for the one or more pieces of desktop information on the current desktop include at least one of:
a desktop presentation mode contains one card, and the one or more pieces of desktop information is arranged in the card according to the time property information of the desktop information;
the desktop presentation mode contains a plurality of cards of different types, and the one or more pieces of desktop information are respectively presented in at least one of the cards according to the type of the desktop information or the type of an application to which the desktop information belonged, and multiple pieces of desktop information in one card is arranged according to the time property information of the desktop information;
the desktop presentation mode contains a plurality of cards of different types, and the one or more pieces of desktop information are respectively presented in at least one of the cards according to a frequency of use of the application to which the desktop information belonged, and multiple pieces of desktop information in one card is arranged according to the time property information of the desktop information; and
the desktop presentation mode contains a timeline, and the one or more pieces of desktop information is arranged along the timeline according to the time property information of the desktop information.

15. The method according to claim 1, wherein the step of presenting the current desktop of the mobile device according to the one or more pieces of desktop information, comprising:
updating the current desktop of the mobile device according to the one or more pieces of desktop information.

16. A method for providing a desktop at a network device, comprising:
determining one or more pieces of candidate desktop information corresponding to a mobile device from an application message pushed by an application server; and
sending the one or more pieces of candidate desktop information to the mobile device.

17. The method according to claim 16, wherein the method further comprising:
screening the one or more pieces of candidate desktop information based on a user profile model of a corresponding user of the mobile device;
wherein sending the one or more pieces of candidate desktop information to the mobile device comprising:
sending screened one or more pieces of candidate desktop information to the mobile device.

18. The method according to claim 17, wherein the step of screening the one or more pieces of candidate desktop information based on the user profile model of the corresponding user of the mobile device, comprising:
screening the one or more pieces of candidate desktop information based on the user profile model of the corresponding user of the mobile device and application related information corresponding to the candidate desktop information.

19. The method according to claim 18, wherein the application related information includes at least one of:
frequency of use information of an application corresponding to the candidate desktop information on the mobile device;
accumulated time of use information of an application corresponding to the candidate desktop information on the mobile device;
the time of the latest use information of an application corresponding to the candidate desktop information on the mobile device; and
generation time information of the candidate desktop information at a corresponding application server.

20. A mobile device for providing a desktop, the mobile device comprising:
a processor; and
a memory configured to store computer executable instructions, wherein the executable instructions, when executed, cause the processor to perform the operations:
acquiring one or more pieces of desktop information of the mobile device, wherein at least one of the one or more pieces of desktop information is selected and determined based on a user profile model of a corresponding user of the mobile device; and
presenting a current desktop of the mobile device according to the one or more pieces of desktop information.
